(19) United States
(12) Patent Application Publication
(10) Pub. No.: US 2012/0275371 A1
(43) Pub. Date: Nov. 1, 2012

(54) CELL RESELECTION PROCESS FOR WIRELESS COMMUNICATIONS

(75) Inventors: Shankar Somasundaram, Mountain View, CA (US); Mohammed Sammour, Amman (JO); Ulises Olvera-Hernandez, Kirkland (CA)

(73) Assignee: INTERDIGITAL TECHNOLOGY CORPORATION, Wilmington, DE (US)

(21) Appl. No.: 13/543,263

(22) Filed: Jul. 6, 2012

Related U.S. Application Data
(63) Continuation of application No. 12/047,786, filed on Mar. 13, 2008.
(60) Provisional application No. 60/894,588, filed on Mar. 13, 2007.

(51) Int. Cl. H04W 4/06; H04W 36/00

(52) U.S. Cl. 370/312

(57) ABSTRACT

A method of cell reselection in a wireless communications system where parameters are transmitted by the network in system information blocks to WTRU's on the network. Parameters are either added or subtracted from an equation representing the signal level and/or quality of a cell. Parameters may be prioritized. The results of the calculations are used to rank the servicing cell and neighboring cells. If a neighboring cell has a higher quality than the servicing cell, then the WTRU reselects the better cell. The network may transmit a blacklist of cells where the WTRU cannot camp as well as a barring timer for each cell where if the timer expires, the cell can again be considered for reselection. Information germane to the reselection decision may be transmitted and used by the network.

### CROSS REFERENCE TO RELATED APPLICATIONS

This application is a continuation of U.S. patent application Ser. No. 12/047,786, filed Mar. 13, 2008 (Attorney Docket Ref.: 2-1631.01.US), which application claims the benefit of U.S. Provisional Patent Application Ser. No. 60/894,588 filed on Mar. 13, 2007; both of which are incorporated by reference as if fully set forth herein.

### FIELD OF INVENTION

The present invention is related to wireless communication systems. More particularly, the present invention is related to cell reselection in wireless devices.

### BACKGROUND

The Third Generation Partnership Project (3GPP) standards group has recently initiated the Long Term Evolution (LTE) program to bring new technology, new network architecture, configurations and new applications and services to wireless cellular networks in order to provide improved spectral efficiency, reduced latency, faster user experiences and richer applications and services with less cost. LTE aims at realizing an Evolved Universal Mobile Telecommunications system (UMTS) Terrestrial Radio Access Network (E-UTRAN).

In a Universal Mobile Telecommunications System (UMTS), when a Wireless Transmit/Receive Unit (WTRU) is camped on a cell, it regularly searches for a better cell according to a set of criteria. If a better cell is found, that cell is selected. In earlier UMTS systems, the WTRU may perform cell reselection either in Idle mode or on the forward access channel (FACH) or the paging channel (PCH). In LTE with only 2 states: LTE_Idle and LTE_active, the WTRU can perform cell reselection only in the LTE_idle state.

In prior systems, before a WTRU decides to camp on a cell, it is required to check basic criteria for the cell on which it is camping. S_{qual}>0 AND Sᵣₓₗₑᵥ>0 is the condition that needs to be satisfied to camp on a cell. S_{qual} is measured as:

$${S}_{qual} = \frac{{E}_{c}}{{I}_{o}} - {Q}_{qualmin} \qquad Equation ( 1 )$$

where

$$\frac{{E}_{c}}{{I}_{0}}$$

is a signal to interference ratio of a corresponding cell, measured by the WTRU, and Q_{qualmin} is obtained from system information block 3 (SIB3), which is broadcast by the system.

The signal receive level, Sᵣₓₗₑᵥ is measured as:

Sᵣₓₗₑᵥ=RSCP−Qᵣₓₗₑᵥₘᵢₙ−max(UE_TXPWR_MAX_RACH−P_MAX,0) Equation (2)

where received signal code power (RSCP) is measured by the WTRU and Qᵣₓₗₑᵥₘᵢₙ the minimum required quality is measured based on RSCP, and UE_TXPWR_MAX_RACH, the maximum allowed uplink transmitter power, are system parameters transmitted in SIB3 as explained below.

Along with Q_{qualmin}, Qᵣₓₗₑᵥₘᵢₙ and UE_TXPWR_MAX_RACH, other parameters are transmitted in SIB3 and SIB11 for cell reselection, including, but not limited to the following parameters that are transmitted in SIB 3:
S_{intrasrch} (optional): Measure intra-frequency neighbor cells when S_{qual}≦S_{intrasearch}. Always measure intra-frequency neighbor cells when not specified.
S_{intersrch} (optional): Measure inter-frequency neighbor cells when S_{qual}≦S_{intersearch}. Always measure inter-frequency neighbor cells when not specified.
SsearchRAT (optional): Measure inter-Radio Access Technology (RAT) neighbor cells when S_{qual}≦S_{searchRAT}. Always measure inter-RAT neighbor cells when not specified.
Q_{hyst1s}: Used in ranking serving cell based on Reference Signal Code Power (RSCP).
Q_{hyst2s}: Used in ranking serving cell based on Ec/Io.
Q_{qualmin}: Minimum required quality measure based on Ec/Io.
Qᵣₓₗₑᵥₘᵢₙ: Minimum required quality measure based on RSCP.
UE_TXPWR_MAX_RACH: Maximum allowed uplink (UL) TX power
T_{reselection}: Time in which a neighbor cell preferably meets cell reselection criteria for WTRU to reselect.
Cell Selection and Reselection Quality Measure: Ec/Io or RSCP: specifies the measurement quantity on which a ranking should be based.

The following are parameters transmitted in System Information Block (SIB) 11:
Neighbor List.
Q_{offset1s,n}: Quality Offset used to rank cell based on RSCP.
Q_{offset2s,n}: Quality Offset used to rank cell based on Ec/Io.
UE_TXPWR_MAX_RACH: Maximum allowed uplink (UL) transmitter (TX) Power for neighbor cell.
Q_{qualmin}: Minimum required quality measure based on Ec/Io.
Qᵣₓₗₑᵥₘᵢₙ: Minimum required quality measure based on RSCP.

Using these parameters, the WTRU is able to rank its serving and neighbor cells. The equation for ranking the serving cell is given as:

Rank_{—}s=Ec/Io+Q_{hyst2}+Q_{offmbms}. Equation (3)

The equation for ranking neighbor cells is given as:

Rank_{—}n=Ec/Io−Q_{offset2}+Q_{offmbms}. Equation (4)

Similar ranking equations are present when the measurement quantity is RSCP. The signalled value Q_{offmbms} is added to those cells (serving or neighboring) that belong to the multimedia broadcast/multicast service (MBMS) preferred frequency layer (PL).

Using the above criteria for cell reselection, however, does not take into account other factors such as cell loading and WTRU bandwidth capabilities. In LTE, where Orthogonal Frequency Division Multiplexing (OFDM) is the physical layer medium, these factors play an important role in driving the cell reselection process. In the development of LTE, in addition to considering cell load and WTRU bandwidth capability, other factors that have been considered are found in Table 1 below.

TABLE 1

| | | | Intra- | Inter- | |
|---|---|---|---|---|---|
| | | | fre- | fre- | Inter- |
| | # | Drivers/limitations | quency | quency | RAT |
| Driv- | 1 | Best radio condition | X | X | X |
| ers | 2 | Camp load balancing | | X | X |
| | 3 | Traffic load balancing | | X | X |
| | 4 | UE capability | | X | X |
| | 5 | Hierarchical cell structures | | X | X |
| | 6 | Network sharing | | X | X |
| | 7 | Private networks/home cells | | X | X |
| | 8 | Subscription based mobility control | | X | X |
| | 9 | Service based mobility control | | X | X |
| | 10 | MBMS | | X | X |
| Lim- | 11 | UE battery saving | X | X | X |
| ita- | 12 | Network signalling/processing load | X | X | X |
| tions | 13 | U-plane interruption and data loss | X | X | X |
| | 14 | OAM complexity | X | X | X |

The drivers included in Table 1 are described in detail in below:

Best Radio Condition

The primary purpose of cell reselection, regardless of intra-frequency, inter-frequency, or inter-RAT, is to ensure that the UE camps on/connects to the best cell in terms of radio condition, e.g., path loss, received reference signal power, or received reference symbol Es/Io.

Camp Load Balancing

This is to distribute idle state UEs among the available bands/carriers/RATs, such that upon activation, the traffic loading of the bands/carriers/RATs would be balanced.

Traffic Load Balancing

This is to balance the loading of active state UEs, using redirection for example. In E-UTRAN, traffic load balancing is essential because of the shared channel nature. That is, the user throughput decreases as the number of active UEs in the cell increases, and the loading directly impacts on the user perception.

UE Capability

As E-UTRAN bands/carriers may be extended in the future, UEs having different band capabilities may coexist within a network. It is also likely that roaming UEs have different band capabilities. Overlaying different RATs adds to this variety.

Hierarchical Cell Structures

As in UTRAN, hierarchical cell structures (HCS) may be utilised in EUTRAN to cover for example, indoors and hot spots efficiently. It is possible that E-UTRAN is initially deployed only at hot spots, in which case this driver becomes essential for inter-RAT, not just for inter-frequency. Another use case would be to deploy a large umbrella cell to cover a vast area without having to deploy a number of regular cells, while providing capacity by the regular cells on another frequency.

Network Sharing

At the edge of a shared portion of a network, it will be necessary to direct UEs belonging to different Pubilc Land Mobile Networks (PLMNs) to different target cells. The mobility solutions in both idle and active states should therefore support differentiation between UEs of different operators.

Private Network/Home Cells

Cells that are part of a sub-network should prioritise the camping on that sub-network. UEs that do not belong to private sub-networks should not attempt to camp or access them.

Subscription Based Mobility Control

This mobility driver aims to limit the inter-RAT mobility for certain UEs, e.g., based on subscription or other operator policies.

Service Based Mobility Control

An operator may have different policies in allocating frequencies to certain services. For example, the operator may concentrate Voice over Internet Protocol (VoIP) UEs to a certain frequency layer or RAT (e.g., UTRAN or GERAN), if evaluations prove this effective.

MBMS

As MBMS services may be provided only in certain frequency layers, it may be beneficial/necessary to control inter-frequency/RAT mobility depending on whether the UE receives a particular MBMS service or not.

Limitations for Mobility Control

While the issues mentioned above drive E-UTRAN towards “aggressive” mobility control, the limiting factors also have to be considered. The factors listed below apply to all intra-frequency, inter-frequency, and inter-RAT mobility scenarios.

UE Battery Saving

The mobility solution should not consume excessive UE battery, e.g., due to measurements, measurement reporting, broadcast channel (BCH) reception, or terminal adapter (TA) update signalling.

Network Signalling/Processing Load

The mobility solution should not cause excessive network signalling/processing load. This includes over-the-air signalling, S1/X2 signalling, and processing load at network nodes. Unnecessary handovers and cell reselections should be avoided, and paging channel (PCH) and BCH signallings, as well as dedicated signallings, should be limited. This could be achieved by similar countermeasures as for UE battery saving.

U-Plane Interruption and Data Loss

U-Plane interruption and data loss caused by the mobility solution should be limited. The required QoS should be satisfied in any case.

Operation, Administration and Maintenance (OAM) Complexity

The mobility solution should not demand excessive efforts in operating/maintaining a network. For example, when a new e Node B (eNB) is added or an existing eNB fails, the mobility solution should not incur excessive efforts to set up or modify the parameters.

In view of the increasing complexity in the cell reselection process, it would be beneficial to have a method by which the WTRU and the network would signal information relating to the reselection process to each other.

### SUMMARY

A method of signaling network and WTRU parameters between the WTRU and the network involve defining the cell reselection algorithm to incorporate important parameters relating to the cell reselection process. A process for prioritizing different parameters is also disclosed. A signaling scheme for the communication of the reasons for cell reselection from the WTRU to the network is also disclosed whereby the network is informed on the reasons for the reselection decision.

### BRIEF DESCRIPTION OF THE DRAWINGS

FIG. 1 is an illustration of equations used for cell reselection.

FIG. 2 is a block diagram depicting the use of a cell load parameter in cell relection.

FIG. 3 is a block diagram depicting the use of a bandwidth capability parameter in cell relection.

FIG. 4 is a block diagram depicting the use of a subscribed services parameter in cell relection.

FIG. 5 is a block diagram depicting the use of a blacklist in cell reselection.

FIG. 6 is a block diagram showing how MBMS cells may be included or excluded in cell reselection.

FIG. 7 is a block diagram depicting a method of assigning priorities to parameters used in cell reselection.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The following is a list of factors that may affect the reselection decision, that are preferably used in one embodiment of the present invention:

1. WTRU measurements;

2. Offset and hysterisis value transmitted by the network;

3. Cell Loading;

4. WTRU and Network BW capabilities;

5. MBMS;

6. Best Radio Condition;

7. Camp Load Balancing;

8. Traffic Load Balancing;

9. UE Capability;

10. Hierarchical Cell Structures;

11. Network Sharing;

12. Private Networks/Home Cells;

13. Subscription Based Mobility Control;

14. Service Based Mobility Control;

15. MBMS;

16. UE Battery Saving;

17. Network Signalling/Processing Load;

18. U-Plane Interruption and Data Loss; and

19. Operations, Administration, and Maintenance (OAM) Complexity.

WTRU measurement, and offset and hysterisis value transmitted by the network is incorporated in the cell reselection criteria. An offset for MBMS cells is also included. However, the MBMS criterion is modified to allow the WTRU and the network to make decisions as to camping on MBMS cells.

Cell loading, and WTRU and network bandwidth capabilities, are also herein introduced as reselection parameters.

In the following description, examples are provided for performing calculations to rank cells for reselection. In the Long Term Evolution (LTE) project, the measurements used for cell quality are Reference Signal Received Power (RSRP) and Reference Signal Received Quality (RSRQ). In previous versions of Universal Mobile Telecommunications Systems (UMTS), Received Signal Code Power (RSCP) and the signal to interference ratio Ec/Io were used, respectively. While examples provided may use the above mentioned quantities to perform reselection ranking measurements, these quantities may be substituted by any other suitable signal power or signal quality measure without falling outside the intended scope of this specification. One skilled in the art would recognize that if any other measurements were used in the cell reselection process, that the concepts disclosed herein would be equally applicable to such other measurements and thereby fall within the scope of this specification as well.

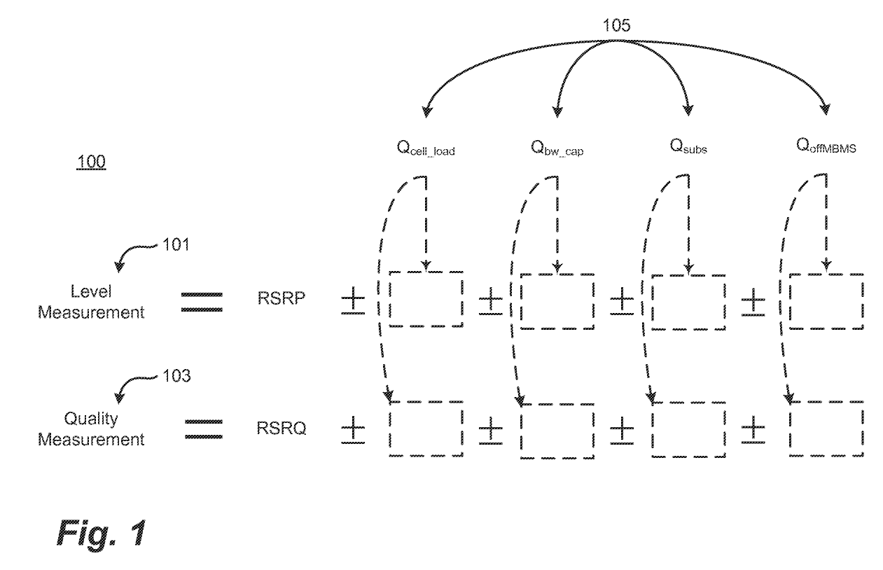

A WTRU receives various pieces of information from the network System Information Blocks (SIB). Information received factors into the cell reselection decision process. In FIG. 1, an illustration 100 depicting ranking cells for reselection using certain parameters in a reselection algorithm is shown. A signal between a WTRU and a cell under consideration is measured with respect to the signal power and the signal quality. Signal power may be quantified for comparison with other cells' signals using a signal power measurement equation 101. Likewise, the signal quality may be quantified for comparison against other cells' quality measurement by using a quality measurement equation 103.

In this example, Reference Signal Receive Power (RSRP) is used as a basis for signal power quality in the power measurement equation 101. Reference Signal Receive Quality (RSRQ) is used as basis for signal quality as shown in the quality measurement equation 103. Other parameters 105a, 105b, 105c and 105d are shown. They include parameters representing cell load, bandwidth capability, subscribed services of the WTRU, and whether the cell is a MBMS cell. These parameters, which are discussed in greater detail below, are substituted into the power measurement equation 101 and/or the quality measurement equation 103 as determined by the WTRU during the ranking process for cell reselection. For example, if the WTRU was prioritizing cell selection based on the services to which the WTRU was subscribed, the parameter Q_{subs} 105c would be substituted into the power measurement equation 101 and the quality measurement equation 103. Adding the parameter 105a, 105b, 105c, 105d to the equation will increase the power or quality measurement, respectively. When using the measurement in the ranking process, a higher quality or power measurement will make it more likely that the cell being considered will be selected for reselection. Conversely, if the parameter 105a, 105b, 105c, 105d is subtracted from the power measurement equation 101 or quality measurement equation 103, the resulting measurement will be lower, thereby making it less likely that the cell under consideration will be opted for reselection.

More than one parameter 105a, 105b, 105c, 105d may be substituted in the measurement equations 101, 103. They may be added or subtracted from the measurement values in any combination. The nature of the parameter 105a, 105b, 105c, 105d and how the WTRU views the parameter 105a, 105b, 105c, 105d in light of the reselection algorithm determines whether the parameter 105a, 105b, 105c, 105d weighs in favor of selecting the cell, in which case it is added, or weighs against camping on the cell, in which case the parameter 105a, 105b, 105c, 105d is subtracted.

While RSRP and RSRQ are shown here by way of example, any suitable measurement could be used. Various parameters 105a, 105b, 105c, 105d may be added or subtracted as indicated to perform a cell reselection ranking and still fall within the intended scope of this disclosure.

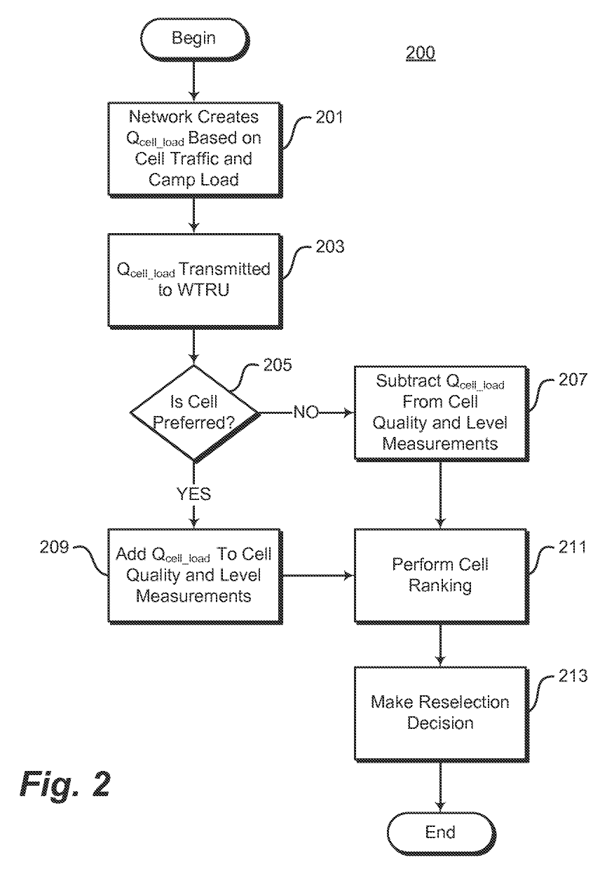

A method 200 of using a cell parameter Q_{cell}_{_{—}}_{load} is shown in FIG. 2. The network creates a parameter Q_{cell}_{_{—}}_{load} that may represent the traffic loading of the cell or the camp loading of the cell (block 201). In another embodiment, Q_{cell}_{_{—}}_{load} may be a single parameter that represents both the traffic and camp loading of the cell. In another embodiment, the parameter Q_{cell}_{_{—}}_{load} may represent the amount of resources left in a particular cell.

After the parameter Q_{cell}_{_{—}}_{load} has been determined, the network transmits the parameter to a WTRU, signaling the parameter in the system information block (block 203). The parameter Q_{cell}_{_{—}}_{load} has not been incorporated in Q_{qualmin} and Qᵣₓₗₑᵥₘᵢₙ because it is a parameter whose value could vary from cell to cell across different time periods. However, in an embodiment the cell loading parameter Q_{cell}_{_{—}}_{load} could be incorporated in the parameters Q_{qualmin} and Qᵣₓₗₑᵥₘᵢₙ which would then vary across different cells across different time intervals. It may also be treated as an optional parameter where the network might not transmit Q_{cell}_{_{—}}_{load}, whereby the WTRU's criteria for camping on that cell is comprised of the other factors being used in the reselection process. When the status of a cell changes, Q_{cell}_{_{—}}_{load} would need to be re-transmitted or may be configured to re-transmit regularly at some predetermined time interval.

If, based on the value of Q_{cell}_{_{—}}_{load} the cell under consideration is preferred as a cell on which the WTRU would like to camp (block 205), the parameter Q_{cell}_{_{—}}_{load} is added to the signal power and quality measurements for that cell (block 209). By adding the value of Q_{cell}_{_{—}}_{load} to the signal power and quality measurements, the ranking of the cell is increased with respect to other neighboring cells. If the cell under consideration is not a cell on which the WTRU would opt to camp due to the value of Q_{cell}_{_{—}}_{load}, then the value of Q_{cell}_{_{—}}_{load} is subtracted from the signal power and quality measurements (block 207). By subtracting the value of Q_{cell}_{_{—}}_{load}, the cell will have lower signal power and quality measurements as compared with other neighboring cells, thereby making it less likely that the cell will be chosen for cell reselection by the WTRU. After the signal power and quality measurements for the servicing cell and the neighboring cells are calculated, the servicing and neighboring cells are ranked (block 211). If a neighboring cells has higher signal power and/or quality measurements than the current servicing cell, the WTRU will select the cell with the better signal and camp on the better cell (block 213) and the method ends until the next cell ranking.

If a cell is heavily loaded, the network might not want the WTRU to camp on the cell at all. By providing a large value of Q_{cell}_{_{—}}_{load} and transmitting it to the WTRU, then subtracting Q_{cell}_{_{—}}_{load} from the cell's signal power and quality measurements, the likelihood that the cell will be camped on by the WTRU is reduced.

The quality measure for the cell may be written as:

S_{qual}=RSRQ−Q_{qualmin}±Q_{cell}_{_{—}}_{load}. Equation (5)

The signal power may be represented by:

Sᵣₓₗₑᵥ=RSRP−Qₑₓₗₑᵥₘᵢₙ−max(UE_TXPWR_MAXRACH−P_MAX,0)±Q_{cell}_{_{—}}_{load}. Equation (6)

The parameter Q_{cell}_{_{—}}_{load} may also be included along with the other parameters used in cell ranking as shown below. The ranking for the servicing cell may be kept the same:

Rank_{—}s=RSRQₛ+Q_{hyst2}±Q_{offMBMS}. Equation (7)

For the neighboring cell, the equation for ranking may be modified as follows:

Rank_{—}n=RSRQₙ−Min(Q_{offset2}Q_{hyst})±Q_{cell}_{_{—}}_{load}±Q_{bw}_{_{—}}_{cap}±Q_{subs}±Q_{offMBMS}. Equation (8)

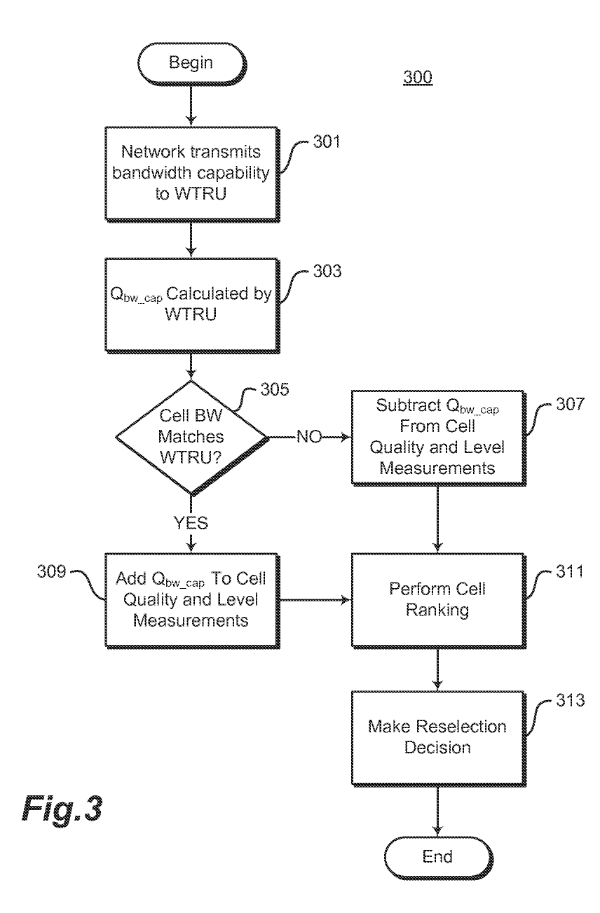

A method 300 of using a cell parameter Q_{bw}_{_{—}}_{cap} is shown in FIG. 3. The bandwidth capabilities of the network are transmitted to the WTRU through a system information (block 301). The WTRU calculates a parameter Q_{bw}_{_{—}}_{cap} based on the bandwidth capabilities signaled by the network (block 303).

If the bandwidth capabilities of the cell under match those of the WTRU (block 305), the parameter Q_{bw}_{_{—}}_{cap} is added to the signal power and quality measurements for that cell (block 309). By adding the value of Q_{bw}_{_{—}}_{cap} to the signal power and quality measurements, the ranking of the cell is increased with respect to other neighboring cells. If the cell under consideration is not a cell on which the WTRU would opt to camp due to a mismatch of the bandwidth capabilities between the cell and the WTRU, then the value of Q_{bw}_{_{—}}_{cap} is subtracted from the signal power and quality measurements (block 307). By subtracting the value of Q_{bw}_{_{—}}_{cap}, the cell will have lower signal power and quality measurements when they are compared with neighboring cells, thereby making it less likely that the cell will be chosen for cell reselection by the WTRU. After the signal power and quality measurements for the servicing cell and the neighboring cells are calculated, the servicing and neighboring cells are ranked (block 311). If a neighboring cells has higher signal power and/or quality measurements than the current servicing cell, the WTRU will select the cell with the better signal and camp on the better cell (block 313) and the method 300 ends until the next cell ranking.

In another embodiment, the WTRU may have signaled its bandwidth capabilities to the network at the initial cell selection, or through a Radio Resource Control (RRC) message after entering the connected state. In such a case, the parameter Q_{bw}_{_{—}}_{cap} may be transmitted by the network and directly added or subtracted from the cell ranking equations.

If the WTRU has previously signaled its bandwidth capability, the network may use that information along with its knowledge of cell resources available and send a single parameter P_{cell}_{_{—}}_{access} combining the two parameters, Q_{cell}_{_{—}}_{load} and Q_{bw}_{_{—}}_{cap}. The parameter P_{cell}_{_{—}}_{access} may either be added or subtracted from the neighbor cell ranking, changing Equation 8 to:

Rank_{—}n=RSRQₙ−Min(Q_{offset2},Q_{hyst})±P_{cell}_{_{—}}_{access}±Q_{subs}±Q_{offMBMS} Equation (9)

Because the subscription services might differ between different WTRUs in the network, it might be difficult for the eNodeB to incorporate the parameter Q_{subs} into P_{cell}_{_{—}}_{access}.

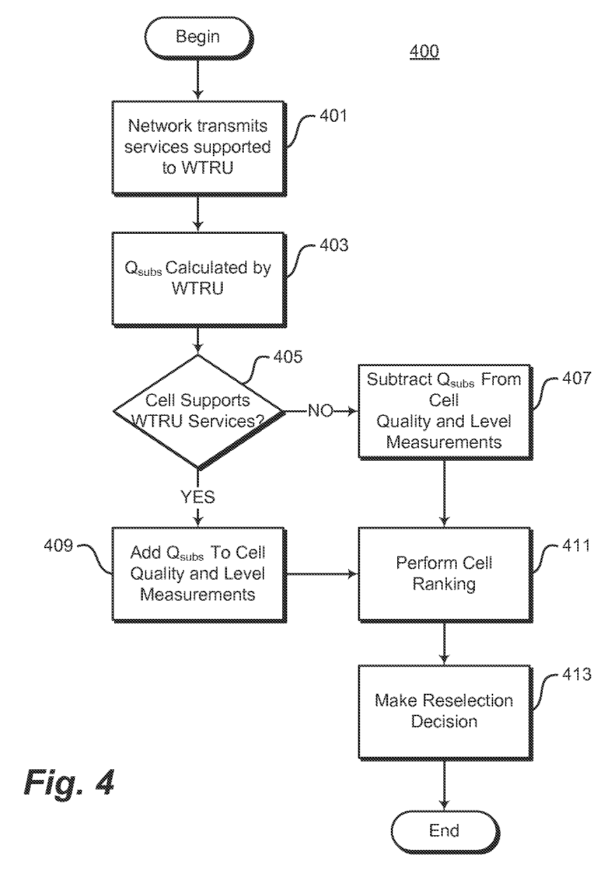

A method 400 of using a cell parameter Q_{subs} is shown in FIG. 4. The network transmits, in the system information block, the services supported by the cell as indicated in block 401. The WTRU then calculates a parameter Q_{subs} based on the services being supported by a cell under consideration (block 403).

If the cell supports the services to which the WTRU is subscribed (block 405), the parameter Q_{subs} is added to the signal level and quality measurements for that cell (block 409). By adding the value of Q_{subs} to the signal power and quality measurements, the ranking of the cell is increased with respect to other neighboring cells. If the cell under consideration is not a cell on which the WTRU would opt to camp because the cell does not support all the services to which the WTRU is subscribed, then the value of Q_{subs} is subtracted from the signal power and quality measurements as shown in block 407. By subtracting the value of Q_{subs}, the cell will have lower signal power and quality measurements as compared with other neighboring cells, thereby making it less likely that the cell will be chosen for cell reselection by the WTRU. After the signal power and quality measurements for the servicing cell and the neighboring cells are calculated, the servicing and neighboring cells are ranked (block 411). If a neighboring cells has higher signal power and/or quality measurements than the current servicing cell, the WTRU will select the cell with the better signal and camp on the better cell (block 413) and the method 400 ends until the next cell ranking.

If a cell does not support a service to which the WTRU is subscribed or wishes to acquire, the WTRU may decide not to camp on that cell based on its lack of support for the service. In such a case, a very large value of Q_{subs} may be subtracted from the signal power and quality measurements of the cell to reduce the cell's ranking and preclude its selection by the WTRU.

In a case where the WTRU has already signaled its bandwidth capability, the network may use that information in combination with its knowledge of cell resources available and may send a blacklist of cells on which the WTRU should not be allowed to camp based on the information. The ranking of neighboring cells in such a case is calculated by:

Rank_{—}n=RSRQₙ−Min(Q_{offset2},Q_{hyst})±Q_{subs}±Q_{offMBMS} Equation (10)

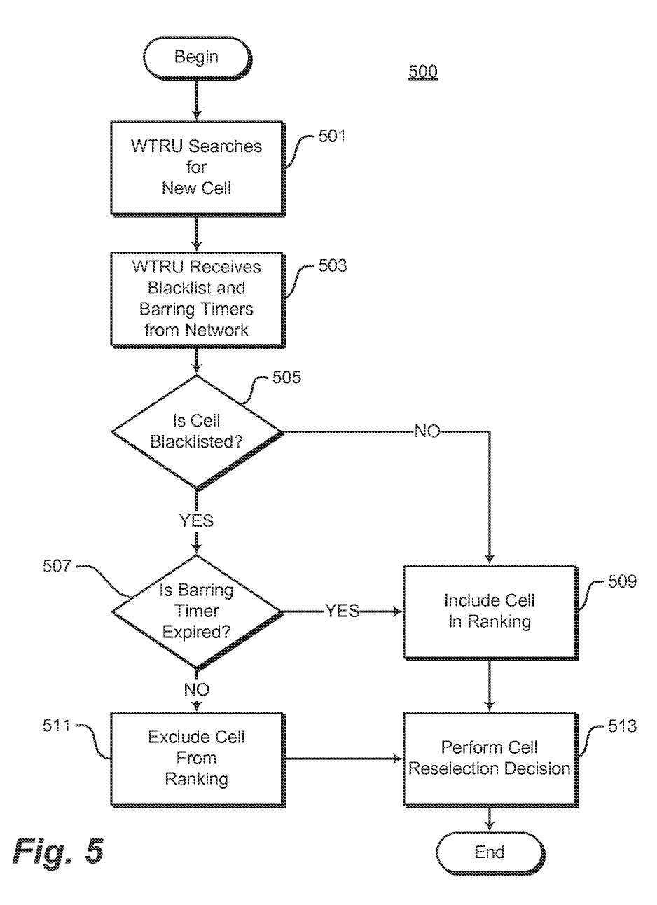

A potential problem exists with blacklisting cells without incorporating cell loading and bandwidth capabilities in that there may be a lightly loaded cell on which the network may want to discourage a WTRU from camping, but not eliminate the cell from cell reselection altogether. This cannot be done with a blacklist. Referring to FIG. 5, a method 500 of using blacklists in cooperation with baring timers is shown. A WTRU periodically searches for a better cell than the cell by which it is currently being serviced (block 501). The network, based on the information provided by the WTRU relating to its bandwidth capabilities and its knowledge of cell resources available, transmits a blacklist of cells on which the WTRU should not be allowed to camp, along with a barring timer indicating the time period that each cell in the blacklist should be barred from camping. The blacklist and barring timers are received by the WTRU (block 503). When ranking the neighboring cells, the WTRU looks to see if the cell under consideration is included in the blacklist (block 505). If the cell is included in the blacklist, the WTRU then looks to see if the barring timer associated with that cell has expired (block 507). If the barring timer has not expired, then the cell is excluded from the cell rankings (block 511). If either the cell is not in the blacklist (block 505), or the barring timer has expired (507) then the cell is included in the cell ranking (block 509). In either case, the cell ranking is used, whether it includes a given cell or not, and a decision to reselect a cell on which to camp is made (block 513) where the method 500 ends.

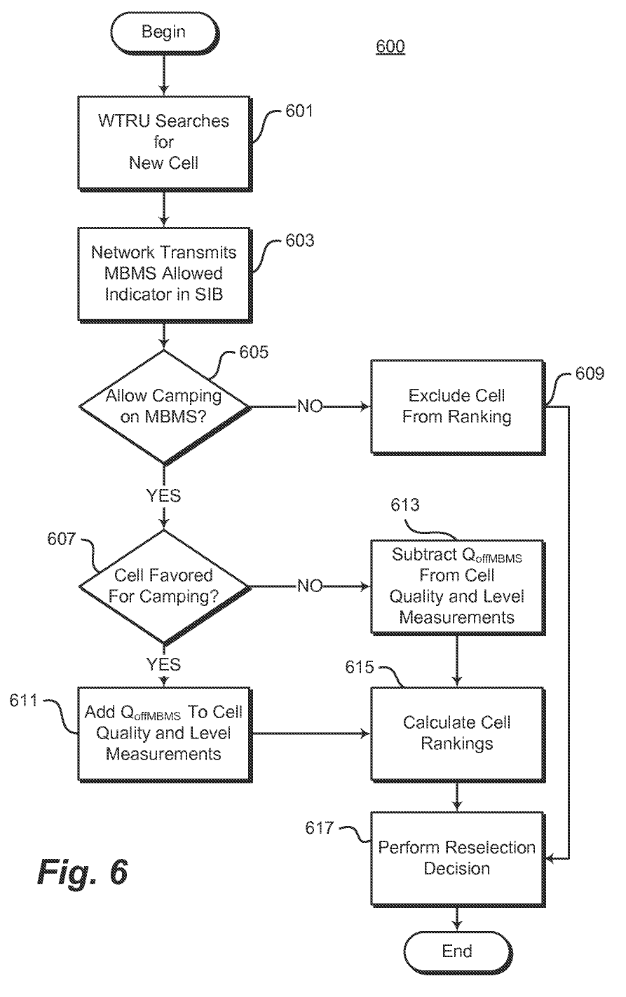

The parameter Q_{offMBMS} could be added or subtracted for Multimedia Broadcast/Multicast Service (MBMS) cells depending on whether the network wants to give priority to those cells. This decision may be made by the network based on the type of service to which the WTRU has subscribed. It may be decided that the network does not want to allow the WTRU camp on MBMS cells. In such a case the cell reselection algorithm could be altered as shown in FIG. 6.

FIG. 6 depicts a method 600 by which the network optionally signals to a WTRU whether the WTRU is permitted to camp on MBMS cells. A WTRU periodically searches for a new cell with a better signal than the cell by which the WTRU is currently being serviced (block 601). The network then transmits an indicator to the WTRU in the system information block which informs the WTRU whether it can camp on MBMS cells (block 603). If the WTRU is permitted to camp on MBMS cells, (block 605), it is determined if the cell is favored for some factor making the cell desirable to the WTRU (block 607). If the cell is seen favorably, the value of Q_{offMBMS} is added to the cell signal power and quality measurements (block 611). If the cell is not seen favorably, the value of the parameter Q_{offMBMS} is subtracted from the signal power and quality measurements (block 613).

If in block 605, the network indicates that the WTRU may not camp on MBMS cells, the WTRU excludes a cell that the network indicates is a MBMS cell from the cell ranking and MBMS cells are not considered in the cell ranking process. Rankings of cell based on signal power and quality measurements are made for all neighboring cells on which the WTRU is permitted to camp (block 615) and if a cell is found to have higher measurements than the cell currently servicing the WTRU, then a cell reselection is made (block 617) and the method 600 ends.

In some scenarios, the network may also want to give more priority to some parameters like WTRU measurements over other parameters like bandwidth capabilities or cell loading. The network may signal the absolute of relative priority indications between the different parameters and the WTRU can make use of the priority information to adjust its cell reselection criteria according to certain predefined rules. Alternatively, the network may signal an optional scaling parameter along with the parameter signaled to the WTRU, applying the scaling parameter to the equation. In general, there may be different scaling factors (weights) to each of the ranking parameters and the equations for ranking become:

Rank_{—}s=RSRQₛQ_{hyst2}±Q_{offMBMS} Equation (11)

for servicing cells, and:

Rank_{—}n=RSRQₙ−a*Min(Q_{offset2},Q_{hyst})±b*Q_{cell}_{_{—}}_{load}±c*Q_{bw}_{_{—}}_{cap}±d*Q_{subs}±e*Q_{offMBMS} Equation (12)

for neighboring cells where a, b, c, d, and e are scaling factors for a respective parameter and Q^{offset2} is an offset value based on RSCP, Q_{hyst} is a factor used in ranking based on the hysteresis of the cell and Q_{offMBMS} is a ranking factor offset based on whether the cell is a MBMS cell.

Alternatively, the equation for the neighboring ranking may be written as:

Rank_{—}n=RSRQₙ−Σᵢαᵢ*Qₚₐᵣₐₘ Equation (13)

where index i may go from 0 to a value M depending on the number of parameters present in the equation and where a represents a scaling factor that may go from 0 to a value N. Qₚₐᵣₐₘ represents the different parameters for cell reselection as those mentioned above.

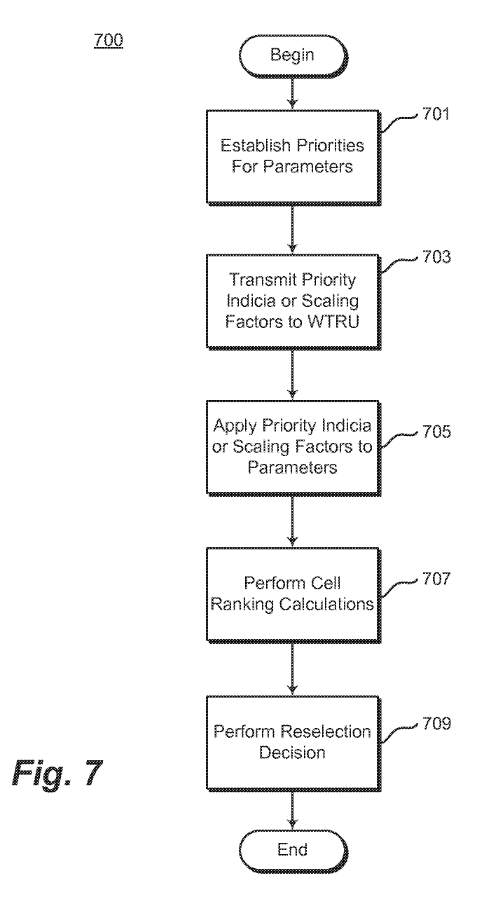

A method of applying scaling factors to the parameters in the cell reselection process 700 is shown in FIG. 7 where the network establishes priorities for one or more parameters being used in the cell reselection procedure (block 701). The network then transmits the priority indicia, or alternatively, a scaling factor to be applied against some or all of the parameters in the reselection equations to the WTRU (block 703). The WTRU applies the priority indicia or scaling factors to the parameters in the cell reselection process (block 705). The equations are then evaluated to compute the signal power and quality measurements for each neighboring cell and the servicing cell and a ranking is performed based on the results of the signal power and quality measurements (block 707). If a cell is found to have higher signal power and quality measurement that the servicing cell by which the WTRU is currently being serviced, a decision to perform cell reselection and camp on the better cell is made as shown in block 709 where the cell reselection method ends.

In all of the above described scenarios, a network could also be given the option of not signaling some of the parameters for ranking or threshold detection depending on the scenario and services running on the WTRU. In this case the WTRU may use whatever parameters it derives or are received from the network to perform the ranking calculations.

Additionally, it may be helpful if the network knew the reasons why a cell performed a reselection. Information relating to the reasons why the WTRU camped on a new cell, such as the top factor in making the reselection decision the top N reasons why a new cell was selected may be transmitted to the network. With the reasons why WTRUs are reselecting cells, such as for the services being supported in certain cells, the network may use that information in load balancing and as input to the values of parameters to be transmitted by the network for the cell reselection process.

If, during the system information reading stage, a neighbor cell has prior knowledge of a WTRU's capabilities, subscription services, and knowledge of its own resources, it may indicate to the WTRU whether or not it wants to allow the WTRU to camp on the cell at that time. If the neighbor cell did not want to allow the WTRU to camp on it, the WTRU may then camp on the next cell in its ranking list. If the neighbor cell allowed the WTRU to camp on it, then the WTRU may reselect that cell for camping.

Although the features and elements are described in the embodiments in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage media include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs)

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands-free headset, a keyboard, a Bluetooth® module, a frequency modulated (FM) radio unit, a liquid crystal display (LCD) unit, an organic light-emitting diode (OLED) display unit, a digital music player, a media player, a video game player module, an Internet browser, and/or any wireless local area network (WLAN) module.

What is claimed is:

1. A method of providing wireless communication services, the method comprising:
receiving, from a serving cell eNodeB, cell information associated with target cell evolved Node-Bs (eNodeBs) that neighbor the serving cell eNodeB;
evaluating, at a wireless transmit and/or receive unit (WTRU), cell reselection criteria including preference given to multimedia broadcast multicast services (MBMS) frequencies the WTRU is receiving via a MBMS single frequency network (MBSFN);
determining, at the WTRU, a neighboring target cell eNodeB to reselect to based, at least in part, on the preference given to MBMS frequencies the WTRU is receiving; and
receiving and reading master information block (MIB) and system information messages of the neighboring target cell eNodeB.

2. The method of claim 1, further comprising: reselecting to the neighboring target cell.

3. The method of claim 1, wherein determining a neighboring target cell eNodeB to reselect to comprises: determining the neighboring target cell eNodeB to reselect to based, at least in part, on the preference given to frequencies of the MBMS frequencies the WTRU is receiving.

4. A wireless transmit/receive unit (WTRU) comprising a receiver, processor and a transmitter, wherein:
the receiver is configured to receive, from a serving cell eNodeB, cell information associated with target cell evolved Node-Bs (eNodeBs) that neighbor the serving cell eNodeB;
the processor is configured to:
evaluate cell reselection criteria including preference given to multimedia broadcast multicast services (MBMS) frequencies the WTRU is receiving via a MBMS single frequency network (MBSFN); and
determine a neighboring target cell eNodeB to reselect to based, at least in part, on the preference given to MBMS frequencies the WTRU is receiving; and
the receiver is configured to receive and read master information block (MIB) and system information messages of the neighboring target cell eNodeB.

5. The WTRU of claim 4, wherein the processor is configured to reselect to the neighboring target cell eNodeB.

6. The WTRU of claim 4, wherein the processor is configured to determine the neighboring target cell eNodeB to reselect to based, at least in part, on the preference given to frequencies of the MBMS frequencies the WTRU is receiving.

7. A method of providing wireless communication services, the method comprising:
receiving neighbor cell information and capability information for a multimedia broadcast multicast services (MBMS) single frequency network (MBSFN);
transmitting, to a wireless transmit/receive unit (WTRU), cell information associated with target cell evolved Node-Bs (eNodeBs) that neighbor a serving cell eNodeB, the cell information including multimedia broadcast multicast services (MBMS) frequencies associated with the target cell eNodeBs so as to allow the WTRU to determine a neighboring target cell eNodeBs to reselect to.

8. A serving cell evolved Node-B (eNodeB) for providing wireless communication services, the eNodeB comprising:
a receiver configured to receive cell information associated with target cell evolved Node-Bs (eNodeBs) for a multimedia broadcast multicast services (MBMS) single frequency network (MBSFN); and
a transmitter configured to transmit, to a wireless transmit/receive unit (WTRU), the received cell information, the cell information including multimedia broadcast multicast services (MBMS) frequencies associated with the target cell eNodeBs so as to allow the WTRU to determine a neighboring target cell eNodeBs to reselect to.

9. A method of providing wireless communication services, the method comprising:
receiving, from a serving cell eNodeB, cell information associated with target cell evolved Node-Bs (eNodeBs) that neighbor the serving cell eNodeB;
evaluating, at a wireless transmit and/or receive unit (WTRU), cell reselection criteria including preference given to multimedia broadcast multicast services (MBMS) frequencies the WTRU is interested in receiving via a MBMS single frequency network (MBSFN);
determining, at the WTRU, a neighboring target cell eNodeB to reselect to based, at least in part, on the preference given to MBMS frequencies the WTRU is interested in receiving; and
receiving and reading master information block (MIB) and system information messages of the neighboring target cell eNodeB.

10. The method of claim 9, further comprising: reselecting to the neighboring target cell.

11. The method of claim 9, wherein determining a neighboring target cell eNodeB to reselect to comprises: determining the neighboring target cell eNodeB to reselect to based, at least in part, on the preference given to frequencies of the MBMS frequencies the WTRU is currently and/or interested in receiving.

12. A wireless transmit/receive unit (WTRU) comprising a receiver, processor and a transmitter, wherein:
the receiver is configured to receive, from a serving cell eNodeB, cell information associated with target cell evolved Node-Bs (eNodeBs) that neighbor the serving cell eNodeB;
the processor is configured to:
evaluate cell reselection criteria including preference given to multimedia broadcast multicast services (MBMS) frequencies the WTRU is interested in receiving via a MBMS single frequency network (MBSFN); and
determine a neighboring target cell eNodeB to reselect to based, at least in part, on the preference given to MBMS frequencies the WTRU is interested in receiving; and
the receiver is configured to receive and read master information block (MIB) and system information messages of the neighboring target cell eNodeB.

13. The WTRU of claim 12, wherein the processor is configured to reselect to the neighboring target cell eNodeB.

14. The WTRU of claim 12, wherein the processor is configured to determine the neighboring target cell eNodeB to reselect to based, at least in part, on the preference given to frequencies of the MBMS frequencies the WTRU is currently and/or interested in receiving.
